(19) United States
(12) Patent Application Publication
(10) Pub. No.: US 2021/0066825 A1
(43) Pub. Date: Mar. 4, 2021

(54) FUSING DEVICE AND METHOD FOR JOINING ELECTRICAL TERMINALS PREPOPULATED IN A CONTACT CARRIER WITH ELECTRICAL CONDUCTORS

(71) Applicant: Turck Inc., Plymouth, MN (US)

(72) Inventors: Kaisa Sylvia Eno, Arden Hills, MN (US); John Brendan O Rourke, Brooklyn Park, MN (US); Marco Luke Mathias, Minneapolis, MN (US); Florinel Ciubotaru, Minnetonka, MN (US)

(21) Appl. No.: 16/553,297

(22) Filed: Aug. 28, 2019

(51) Int. Cl. H01R 4/62; H01R 4/02

(52) U.S. Cl. CPC H01R 4/625; H01R 4/029

(57) ABSTRACT

A method for joining an electrical terminal pre-populated in a contact carrier and an electrical conductor includes arranging a connection portion of the electrical conductor at a receiving section of the electrical terminal pre-populated in the contact carrier, arranging at least two electrodes on one or more sides of the receiving section of the electrical terminal pre-populated in the contact carrier receiving the connection portion of the electrical conductor, and fusing the connection portion of the electrical conductor and the receiving section of the electrical terminal pre-populated in the contact carrier by using the electrodes to join the electrical conductor and the electrical terminal pre-populated in the contact carrier.

### FIELD

The invention generally relates to a method and a device for joining electrical terminals, pre-populated in a contact carrier, and an electrical conductor. The invention further generally relates to the assembly of industrial electrical connectors. The invention relates, in particular, to a method and a device for reducing the effort of joining electrical terminals, positioned in a pre-populated contact carrier, and electrical conductors and for facilitating the automation of the assembly.

### BACKGROUND

In the prior art, several methods for joining pre-populated contact carriers with the respective electrical conductors are known.

According to one of these conventional methods the electrical conductors are fixed to the contact carriers by hot tip soldering of the electrical conductors to the terminals in a pre-populated contact carrier. The disadvantages of hot tip soldering comprise in that the soldering process requires a significant amount of time and bears the risk of creating a “cold” solder joint, which results in poor electrical performance of the joint and, thus, inducing a high failure rate of the electrical components. Furthermore, hot tip soldering requires the application of solder material (a consumable) to the electrical terminal and the conductor during the hot tip soldering operation, which might be disadvantageous for some industrial connectors and, depending on the type of solder used, it could be hazardous to the operator.

In prior art also an insulation-displacement contact (IDC) is known, also known as insulation-piercing contact (IPC), as another conventional method, which is an electrical connector designed to be connected to the conductor(s) of an insulated cable by a connection process which forces a selectively sharpened blade or blades through the insulation, bypassing the need to strip the conductors of insulation before connecting. When properly made, the connector blade cold-welds to the conductor, making a theoretically reliable gas-tight connection. In comparison to all other methods, this joining method is most limited in regards to operating temperature and current carrying properties. The insulation displacement method shows relatively high electrical resistance across the connection, high voltage drop and low mechanical strength as compared with other electrical conductor to terminal joining methods.

According to another conventional joining method, one or more electrical conductors are joined to the electrical terminals by crimping the electrical terminal to the electrical conductors. This method requires the electrical terminal to be outside of the contact carrier during the process and cannot be performed on electrical terminals pre-populated in contact carriers. Crimping, also poses potential process failure risks, in particular due to improperly calibrated crimp tools. Furthermore, crimping electrical conductors comprising of stranded conductors bears the risk of shifting within the crimp, breaking strands due to mechanical action of the crimper, not capturing all strands in the crimping area and thermal cycling stress of the joint, which may result in sacrificing signal continuity and current carrying capabilities.

Moreover, according to another conventionally known method, a screw terminal can be used for the connection of an electrical conductor to an electrical terminal. This method, however, goes along with typically long processing times and requires additional components, which result in high costs for the connection joint and rules out encapsulation as an environmental protection solution. Besides that, over-tightening may cause damages to the conductors and under-tightening may result in the connection becoming loose over time sacrificing signal continuity and current carrying capabilities.

### SUMMARY

In an embodiment, the present invention provides a method for joining an electrical terminal pre-populated in a contact carrier and an electrical conductor. The method comprises arranging a connection portion of the electrical conductor at a receiving section of the electrical terminal pre-populated in the contact carrier, arranging at least two electrodes on one or more sides of the receiving section of the electrical terminal pre-populated in the contact carrier receiving the connection portion of the electrical conductor, and fusing the connection portion of the electrical conductor and the receiving section of the electrical terminal pre-populated in the contact carrier by using the electrodes to join the electrical conductor and the electrical terminal pre-populated in the contact carrier.

### BRIEF DESCRIPTION OF THE DRAWINGS

FIGS. 1A to 1C depict an example of a contact carrier in a top view (wire side) and in a side view, respectively.

FIGS. 2A to 2E depict several steps of a process for joining an electrical conductor and a contact carrier according to an embodiment of the invention.

FIG. 3 depicts in a schematic flow diagram a method for joining several electrical conductors and a contact carrier according to an embodiment of the invention.

### DETAILED DESCRIPTION OF THE INVENTION

Embodiments of the invention provide reliable, low-cost methods for permanently fusing electrical conductors to electrical terminals pre-loaded and positioned in a contact carrier, which are also suitable for process automation.

Embodiments of the invention provide methods and fusing devices for fusing one or more electrical conductors to one electrical terminal or to a set of electrical terminals pre-populated in a contact carrier.

According to the present invention, a first method is provided for joining an electrical terminal pre-populated in a contact carrier and an electrical conductor. The method comprises arranging a connection portion of the electrical conductor at a receiving section of the electrical terminal pre-populated in the contact carrier. Furthermore, the method comprises arranging at least two electrodes on one or more sides of the receiving section of the electrical terminal pre-populated in the contact carrier receiving the connection portion of the electrical conductor, and fusing the connection portion of the electrical conductor and the receiving section of the electrical terminal pre-populated in the contact carrier by using the electrodes to join the electrical conductor and the electrical terminal pre-populated in the contact carrier.

According to the present invention, a second method is provided for joining a plurality of electrical conductors and a set of electrical terminals pre-populated in a contact carrier. The second method comprises: a) arranging a connection portion of a first electrical conductor of the plurality of electrical conductors at a first receiving section of a first electrical terminal of the set of electrical terminals pre-populated in the contact carrier; b) arranging at least two electrodes on one or more sides of the first receiving section of the first electrical terminal receiving the connection portion of the first electrical conductor; c) fusing the connection portion of the first electrical conductor and the first receiving section of the first electrical terminal pre-populated in the contact carrier by using the electrodes to join the first electrical conductor and the first electrical terminal; d) arranging the connection portion of a second electrical conductor of the plurality of electrical conductors at a receiving section of a second electrical terminal of the set of electrical terminals pre-populated in the contact carrier; e) positioning the contact carrier such as to allow the engagement of the electrodes to the second receiving section of the contact carrier; f) arranging the two electrodes on one or more sides of the second receiving section of the second electrical terminal receiving the connection portion of the second electrical conductor; and g) fusing the connection portion of the second electrical conductor and the receiving section of the second electrical terminal by using the electrodes to join the second electrical conductor and the second electrical terminal.

According to an embodiment, the second method is adapted to join more than two electrical conductors to the plurality of electrical conductors and the set of electrical terminals pre-populated in the contact carrier. The contact carrier contains one electrical terminal of the set of electrical terminals with a receiving section for each of the electrical conductors of the plurality of electrical conductors. Steps d) through g) are accordingly repeated for each respective one of the plurality of electrical conductors to be joined.

According to an embodiment of the second method, the electrical conductor or the plurality of electrical conductors form part of an electrical cable and the electrical conductors are at least partly electrically isolated with respect to each other.

According to embodiments of the second method, the connection portion of the electrical conductor can be arranged at the receiving section of the contact carrier so as to establish an electrical contact between the connection portion of the electrical conductor and the receiving section of one of the electrical terminals pre-populated in the contact carrier. The connection portion of the electrical conductor can also be positioned at the receiving section of one of the electrical terminals pre-populated in the contact carrier along a longitudinal axis of the contact carrier. When the connection portion of the electrical conductor is positioned at the receiving section of one of the electrical terminals pre-populated in the contact carrier along a longitudinal axis of the contact carrier, rearranging the contact carrier in step f) can include rotating the contact carrier at a predetermined angle around the longitudinal axis of the contact carrier.

According to the present invention, a fusing device is provided for joining a plurality electrical conductors and a set of electrical terminals pre-populated in a contact carrier. The fusing device comprises a support unit for receiving the contact carrier such as to allow positioning a connection portion of each of at least a first and a second electrical conductor of the plurality of electrical conductors aligned with at least a first and a second receiving section of the set of electrical terminals, respectively. The fusing device further comprises at least two electrodes engageable with one or more sides of the first receiving section of the set of electrical receiving the connection portion of the first electrical conductor for fusing the connection portion of the first electrical conductor and the first receiving section of the set of electrical terminals to join the electrical conductor and least one of the electrical terminals of the set of electrical terminals. The support unit is adapted to position the contact carrier such as to allow the electrodes engagement to the second receiving section of the set of electrical terminals to allow the electrodes being engaged on one or more sides of the second receiving section of the set of electrical terminals receiving the connection portion of the second electrical conductor for fusing the connection portion of the second electrical conductor and the second receiving section of the set of electrical terminals pre-populated in the contact carrier by using the electrodes to join the second electrical conductor and at least one electrical terminal of the set of electrical terminals.

According to embodiments, the fusing device can further comprise a cable fixturing unit for automatically arranging the connection portion of the first and/or the second electrical conductor of the plurality of electrical conductors at the first or the second receiving section of the set of electrical terminals pre-populated in the contact carrier, respectively. Furthermore, the support unit can be adapted to manually or automatically rotate the contact carrier along a longitudinal axis of the contact carrier and/or to translate the contact carrier at least in a plane perpendicular to the longitudinal axis of the contact carrier.

An electrical conductor according may be for instance a cable or a wire, wherein the electrical conductor may be at least partly electrically isolated. For instance, the electrical conductor may be covered with an insulation layer. The electrical conductor may comprise a solid conductor and/or a stranded conductor. The electrical conductor or the plurality of electrical conductors, respectively, optionally form part of an electrical cable and wherein the electrical conductors are at least partly electrically isolated with respect to each other.

A contact carrier may be a carrier, which may be pre-populated with one or more electrical terminals prior to joining the one or more connecting portions of electrical conductors and receiving sections of each electrical terminal pre-populated in the contact carrier. For instance, the contact carrier may allow some pre-attachment of one or more electrical conductors and/or keep the electrical conductor(s) in place prior to the final fusion process of one or more connecting portions of the electrical wires to the receiving section of an electrical terminals pre-populated in the contact carrier. The contact carrier may form a part of an industrial connector as a standalone assembly or after an optional assembly with other parts of the industrial connector.

Joining one or more electrical conductors and a receiving section of an electrical terminal pre-populated in the contact carrier may comprise mechanically attaching and/or fixing the one or more electrical conductors to the receiving section of the respective electrical terminal pre-populated in the contact carrier. The electrical conductor(s) may be joined with the receiving section of the electrical terminal pre-populated in the contact carrier in such a way that they cannot be separated from each other and/or the electrical contact between the electrical conductors and the electrical terminals pre-populated in the contact carrier may not be disconnected any more.

The connection portion of an electrical conductor may be such a portion of the electrical conductor, which is to be joined with the receiving section of a terminal pre-populated in the contact carrier. The connection portion may be an end portion of the electrical conductor. Optionally, the electrical conductor may be covered with an electrical insulation layer, wherein the insulation layer may be removed from electrical conductor at the connection portion to allow establishing an electrical contact between the connection portion and the receiving section of the electrical terminal pre-populated in the contact carrier.

The receiving section of an electrical terminal pre-populated in the contact carrier may be a part of the electrical terminal, which is adapted to receive the connection portion of an electrical conductor. In particular, the receiving section may be adapted to the size and/or shape of the connection portion of the electrical conductor to allow a pre-population of the contact carrier with the electrical conductor(s). Optionally, an electrical terminal receiving section of the contact carrier may comprise a cavity or a void, in which an electrical terminal may be at least partly inserted for pre-populating the contact carrier with electrical terminals.

The electrodes may be fusing electrodes and may be electrical electrodes allowing the appliance of an electrical current for fusing the electrical conductor(s) to the receiving section of the electrical terminal(s) pre-populated in the contact carrier. In particular, the fusing electrodes may be adapted to allow getting in mechanical and electrical contact with the connection portion of the electrical conductor and/or the receiving section of the electrical terminals pre-populated in the contact carrier to apply a current flow with the intent of heating up and fusing the metal components. Alternatively or additionally, the electrodes may be provided as heating devices (other than a resistance welding equipment) and could be employed by this fusing method. Such devices may include but are not limited to non-contact heating devices, such as lasers, and mechanical heat generation devices, such friction welding devices. Also such heating devices are considered as electrodes or fusing electrodes according to the invention.

The invention provides the advantage of a simple method for fusing one or more electrical conductors and the receiving section of electrical terminals pre-populated in a contact carrier. In particular, the process disadvantages and risks of the conventionally known methods are mitigated.

According to the invention, joining or fusing the electrical conductor(s) to the receiving section of the electrical terminals pre-populated in the contact carrier consumes less time than a conventional soldering process, does not bear the risk of creating “cold” solder joints, does not require the application of soldering materials or other consumables and/or provides an electrical connection superior to the previously known methods.

Furthermore, the invention may provide the advantage of tighter and more stable process controls with feedback loops and data collection capabilities far superior to commonly used fusion methods like crimping and soldering.

Moreover, according to the present invention, no further components are required for completing the electrical connections in an industrial connector, like it is the case with screw terminal connections methods. Therefore this method allows achieving lower raw material costs and quicker assembling times.

Optionally, the electrical conductors could be pressed into the pre-populated contact carrier. This could comprise pressing the connection portion of an electrical conductor into the receiving section of an electrical terminal pre-populated in a contact holder. This can provide the advantage that a temporary mechanical fixturing can be achieved prior to the fusing step. In particular, during the step of pre-attaching the pre populated contact carrier with one or more electrical conductors a proper fixturing may be advantageous.

Optionally, methods according to the invention can be adapted to join more than two electrical conductors, i.e. more than two connection portions of electrical conductors of the plurality electrical conductors, and the receiving sections of the electrical terminals pre-populated in the contact carrier, wherein each receiving section of the electrical terminals pre-populated in contact carrier is fused to one connection portion of one of the electrical conductors of the plurality of electrical conductors, and wherein the steps d) to g), described above, are accordingly repeated for each of the plurality of electrical conductors to be joined, respectively. In other words, for each conductor to be joined with the receiving section of the electrical terminals pre-populated in the contact carrier, the steps d) to g) may be repeated. According to an embodiment, the contact carrier is pre-populated with all the electrical conductors to be joined with the receiving section of the electrical terminals pre-populated in the contact carrier prior to the first fusing step. For this embodiment, proper mechanical fixturing of the connection portion of each electrical conductor to the contact carrier may be advantageous to avoid them becoming loose during repositioning the contact carrier. In another embodiment, each step of fixturing the connection portion of one conductor to the receiving section of the electrical terminals pre-populated in the contact carrier may be followed by a fusing operation of the respective receiving section and connection portion prior to positioning and fixturing the next connection portion to its respective receiving section.

The connection portion of the electrical conductor is optionally positioned at the receiving section of the electrical terminals pre-populated in the contact carrier such as to establish electrical contact between the two components. This facilitates the fusing step of the components using an electrical resistance welding equipment.

The connection portion of the electrical conductor is optionally arranged at the receiving section of the electrical terminals pre-populated in the contact carrier along a longitudinal axis of the contact carrier. For instance, the connection portion may have the shape of a pin and or may for instance be plugged into the receiving section of the electrical terminals pre-populated in the contact carrier. This facilitates the fixturing of the contact carrier with the electrical conductors prior to the fusing operation.

The step of orienting the contact carrier in step (f) optionally comprises rotating the contact carrier at a predetermined angle around the longitudinal axis of the contact carrier. This facilitates the relative positioning of the connection portion of the electrical conductor with respect to the receiving section of the correct electrical terminals pre-populated in the contact carrier, thus, may be advantageous in particular with respect to the automation.

The fusing device optionally further comprises a cable fixturing unit for automatically positioning the receiving section of the first and/or the second electrical terminals pre-populated in the contact carrier and the connection portion of the first or second electrical conductor of the plurality of electrical conductors relative to each other respectively. In other words, the electrical connection unit may be adapted to pre-populate the contact carrier with one or more electrical conductors prior to the fusing step(s).

The support unit is optionally adapted to rotate the contact carrier along a longitudinal axis of the contact carrier and/or to translate the contact carrier at least in a plane perpendicular to the longitudinal axis of the contact carrier. This may facilitate orienting of the receiving section of the electrical terminals pre-populated in the contact carrier with respect to the connecting portion of the electrical conductor(s) and/or may reduce the strain of possible other electrical conductors already fused to other receiving sections of the electrical terminals pre-populated in the contact carrier.

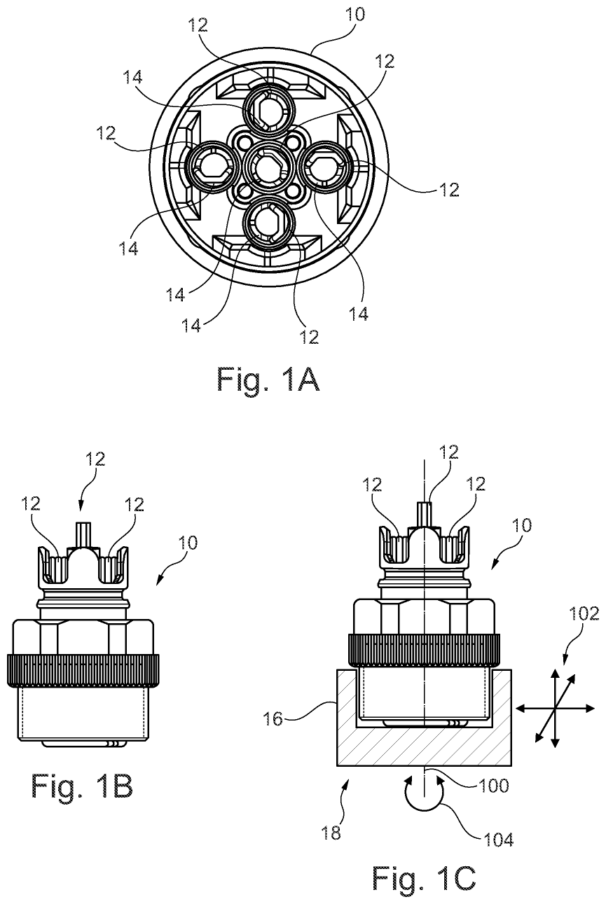

FIG. 1A depicts an example of a contact carrier 10 in a top view (wire side) having five receiving sections 12, which are each pre-populated with electrical terminals 14. The electrical terminal nests 12 are each provided as cylindrical voids for receiving a cylindrical connection portion of a respective electrical terminal 14.

The contact carrier 10 is pre-populated with the electrical terminals 14 in a predetermined arrangement as to allow the electrical terminals 14 being positioned to the contact carrier in fusing step. The contact carrier 10 having the electrical terminals 14 attached thereto may then form a part of an industrial connector. For instance, the contact carrier 10 may be assembled together with other parts to an industrial connector and/or be over molded, sealed or otherwise encapsulated as a standalone industrial connector.

FIG. 1B shows an example of a pre-populated contact carrier 10 in a side view. The receiving section of the electrical terminals pre-populated in the contact carrier 12 are arranged on top of the contact carrier 10 and allow the connection portion of the respective electrical conductors 14 to be positioned at and/or in the receiving sections 12 for pre-populating the contact carrier 10. The contact carrier 10 may be adapted to keep the electrical conductors 14 in the predetermined position prior to the fusing step, such that the contact carrier 10 and the pre-populated electrical conductors 14 may be moved and/or repositioned, for instance to allow the receiving sections 12 being contactable by fusing electrodes, at a certain degree while the contact carriers keeps the electrical conductors 14 in position.

FIG. 1C shows the contact carrier 10 of FIG. 1B inserted in an exemplary depicted support unit 16 of a fusing device 18 according to an embodiment of the invention. The support unit 16 is depicted to receive the contact carrier 10 such that the receiving sections 12 of the contact carrier 10 are accessible for inserting the electrical conductors 14.

The support unit 16 is further adapted to reposition the contact carrier 10 for aligning them to the electrical conductors 14 in the respective receiving sections 12 and/or for fusing the electrical conductors 14 aligned at the receiving sections 12 by at least two electrodes (not shown) of the fusing device 18.

The support unit 16 may be adapted to position the contact carrier 10 by translational movements in one or more of the spatial dimensions, as indicated by the coordinate system 102, and/or by rotating the contact carrier 10 at least for a predetermined angle around a longitudinal axis 100 of the contact carrier 10, as indicated by arrow 104.

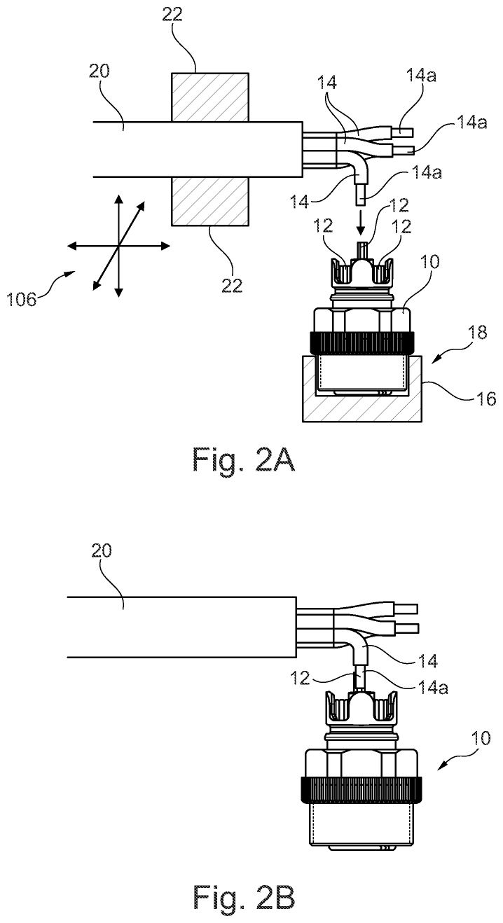

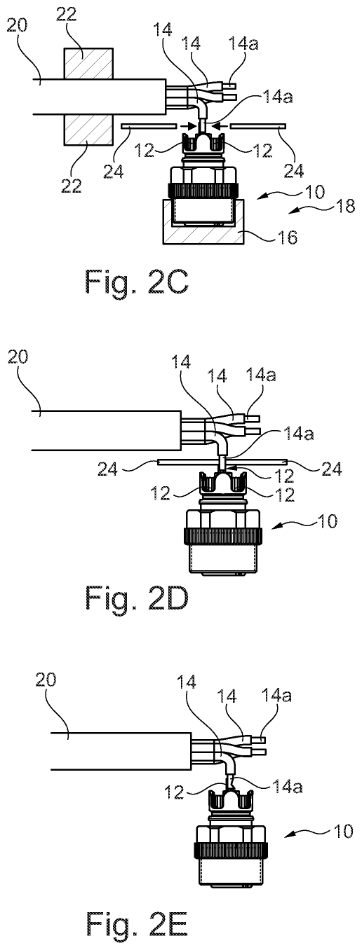

FIGS. 2A to 2E schematically depict a process for joining a plurality of electrical conductors 14 and the receiving section of a set of electrical terminals pre-populated in a contact carrier 10 by using a fusing device 18 according to a preferred embodiment of the invention.

As depicted in FIG. 2A, several electrical conductors 14 of an electrical cable 20 are provided by a cable fixturing unit 22. The cable fixturing unit 22 is adapted to position the cable 20 and, thus, the electrical conductors 14 relative to the contact carrier 10. The fusing device 18 by means of the cable fixturing unit 20 and/or the support unit 16 is adapted to align a first electrical conductor 14 such that the connection portion 14a of the first electrical conductor 14 is positioned at the first receiving section 12 of the electrical terminal pre-populated in the contact carrier. In a pre-determined sequential manner the fusing device aligns the other electrical conductors 14 such as to arrange the respective connection portions 14a at the respective receiving sections 12 of the electrical terminals pre-populated in the contact carrier 10.

This may be achieved for instance by positioning the contact carrier 16 by the support unit by translational movements and or by rotations around the longitudinal axis 100 of the contact carrier 10 to align the contact carrier 10 underneath the respective connection portion of the electrical conductor to be positioned in the respective receiving section 12. The positioning of the connection portion 14a at the respective receiving section may then be achieved by lowering the electrical conductor 14 b means of the cable fixturing unit 22.

According to other embodiments, the cable fixturing unit 22 may be adapted to hold the electrical conductor 14 in a fixed position and to align the electrical conductor 14 at the receiving section 12 by moving the contact carrier 10 towards the connection portion 14a. According to other embodiments, arranging the electrical conductor 14 at the receiving section may comprise moving both of the contact carrier 10 and the electrical conductor 14.

FIG. 2B shows a step of the process, in which the connection portion 14a of the first electrical conductor 14 is aligned at the first receiving section 12 of the correct electrical terminal pre-populated in the contact carrier 10. The arrangement may be achieved by moving the contact carrier 10 towards the electrical conductor 14 and/or by moving the electrical conductor 14 towards the contact carrier 10. For better visibility, the fusing device 18 is not shown in FIG. 2B.

FIG. 2C shows a further step of the process in which two electrodes 24 of the fusing device 18 are positioned on or next to the receiving section 12 receiving the connection portion 14a of the first electrical conductor 14. The fusing electrodes 24 may be moved in a perpendicular direction with respect to the longitudinal axis 100 of the contact carrier 10 towards the receiving section 12 receiving the connection portion 14.

FIG. 2D shows a fusing step of the process, wherein the receiving section 12 receiving the connection portion 14a of the first electrical conductor 14 are fused by the electrodes 24 of the brazing device 18. The fusing may be performed by heating the receiving section 12 and the connection portion 14a by the electrodes 24. By the fusing step, the connection portion 14a needs to be mechanically and electrically fixtured to the receiving section 12. Afterwards, the electrodes 24 need to be removed from the receiving section 12, for instance by moving the electrodes 24 outwards perpendicularly with respect to the longitudinally axis 100 of the contact carrier 10. For better visibility, the support unit 16 and the cable fixturing unit 22 of the fusing device 18 are not shown in FIG. 2D.

FIG. 2E shows the contact carrier 10 with the connection portion 14a of the first electrical conductor 14 joined with the first receiving section 12 of the electrical terminal pre-populated in the contact carrier 10 by fusing. Afterwards, the process may be repeated for joining further electrical conductors 14 to the contact carrier 10. In order to arrange the respective receiving section 12 and the connection portion 14a of the respective electrical conductor 14 in a suitable position to be fused by the electrodes 24, the support unit 16 and for the cable fixturing unit 20 may be used. For instance, first the connection portion may be positioned at and/or in the receiving section 12 of the contact carrier 10 and then the contact carrier may be moved by the support unit 16 to bring the contact carrier 10 in a suitable position to allow engagement of the electrodes 24 at the receiving section 12 to be fused. This may be repeated for each electrical conductor 14 to be joined with the electrical terminals pre-populated in the contact carrier 10. For better visibility, the support unit 16 and cable fixturing unit 22 of the fusing device 18 are not shown in FIG. 2E.

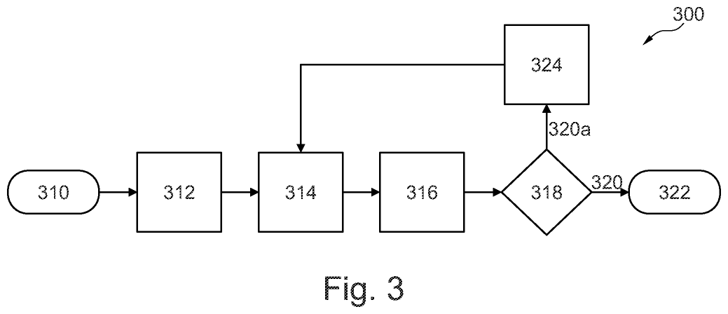

FIG. 3 depicts in a flow diagram a process 300 for joining electrical conductors 14 of a cable 22 with the receiving sections of electrical terminals pre-populated in a contact carrier 10 according to an embodiment. In a first step 310 the process is started.

In step 312, a contact carrier 10 is placed in a support unit 16 of a fusing device 18. Step 312 may be carried out by an operator, for instance by manually inserting a contact carrier 10 into the support unit 16. Alternatively, step 312 may be carried out in an automatic manner by automatically placing a contact carrier 10 in the support unit 10 of the fusing device 18.

In step 314 the connection portion 14a of a first electrical conductor 14 is aligned to the first receiving section 12 of the electrical terminal in the pre-populated contact carrier. Also this step may be performed by an operator by manually arranging the contact carrier 10 and/or the connection portion 14a of the electrical conductor 14. Alternatively, step 314 may be carried out in an automatic manner by automatically moving the support unit 16 and/or the cable fixturing unit 22.

In step 316 the electrodes 24 are arranged at the (first) receiving section and are operated to fuse the receiving section 12 and the connection portion 14a of the electrical conductor positioned therein and/or thereto. Also this step may be performed by an operator and/or automatically be the fusing device 18.

In step 318 it is determined whether the assembly of the contact carrier 10 with the electrical conductors 14 is complete. This may be done by an operator or automatically by the fusing device 18 by using suitable detection means.

In step 320, the determination leads to the result that the assembly is completed and, thus, process is completed and ended in step 322.

Alternatively, in step 320a it is determined that the assembly is not completed and that further electrical conductors 14 are to be joined with the electrical terminals pre-populated in the contact carrier 10. During the following step 324, the contact carrier is repositioned by the support unit, for instance by applying a translational movement and/or a rotational movement of the support unit 16, in order to align the contact carrier 10 in a suitable position for positioning the connection portion 14a of a further electrical conductor 14 at a further receiving section 16 of another receiving section of an electrical terminal pre-populated in the contact carrier 10. The process then continues with step 314 for joining this further electrical conductor 14 to the electrical terminal in the contact carrier 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERNECE NUMERALS

10 contact carrier
12 receiving section
14 electrical conductor
14a connection portion
16 support unit
18 fusing device
20 electrical cable
22 cable fixturing unit
24 electrode
100 longitudinal axis of contact carrier
102 spatial dimensions/coordinate system of support unit
104 rotational directions of support unit
106 spatial dimensions/coordinate system of electrical connection unit

What is claimed is:

1. A method for joining an electrical terminal pre-populated in a contact carrier and an electrical conductor, the method comprising:
arranging a connection portion of the electrical conductor at a receiving section of the electrical terminal pre-populated in the contact carrier;
arranging at least two electrodes on one or more sides of the receiving section of the electrical terminal pre-populated in the contact carrier receiving the connection portion of the electrical conductor; and
fusing the connection portion of the electrical conductor and the receiving section of the electrical terminal pre-populated in the contact carrier by using the electrodes to join the electrical conductor and the electrical terminal pre-populated in the contact carrier.

2. A method for joining a plurality of electrical conductors and a set of electrical terminals pre-populated in a contact carrier, the method comprising:
a) arranging a connection portion of a first electrical conductor of the plurality of electrical conductors at a first receiving section of a first electrical terminal of the set of electrical terminals pre-populated in the contact carrier;
b) arranging at least two electrodes on one or more sides of the first receiving section of the first electrical terminal receiving the connection portion of the first electrical conductor;
c) fusing the connection portion of the first electrical conductor and the first receiving section of the first electrical terminal pre-populated in the contact carrier by using the electrodes to join the first electrical conductor and the first electrical terminal;
d) arranging the connection portion of a second electrical conductor of the plurality of electrical conductors at a receiving section of a second electrical terminal of the set of electrical terminals pre-populated in the contact carrier;
e) positioning the contact carrier such as to allow the engagement of the electrodes to the second receiving section of the contact carrier;
f) arranging the two electrodes on one or more sides of the second receiving section of the second electrical terminal receiving the connection portion of the second electrical conductor; and
g) fusing the connection portion of the second electrical conductor and the receiving section of the second electrical terminal by using the electrodes to join the second electrical conductor and the second electrical terminal.

3. The method according to claim 2, wherein the method is adapted to join more than two electrical conductors of the plurality electrical conductors and the set of electrical terminals pre-populated in the contact carrier, wherein the contact carrier contains one electrical terminal of the set of electrical terminals with a receiving section for each of the electrical conductors of the plurality of electrical conductors, and wherein steps d) through g) are repeated for each respective one of the more than two electrical conductors to be joined.

4. The method according to claim 2, wherein the electrical conductor or the plurality of electrical conductors, respectively, form part of an electrical cable, and wherein the plurality of electrical conductors are at least partly electrically isolated with respect to each other.

5. The method according to claim 2, wherein the connection portion of the first electrical conductor is arranged at the receiving section of the contact carrier so as to establish an electrical contact between the connection portion of the first electrical conductor and the receiving section of one of the electrical terminals pre-populated in the contact carrier.

6. The method according to claim 2, wherein the connection portion of the electrical conductor is positioned at the receiving section of one of the electrical terminals pre-populated in the contact carrier along a longitudinal axis of the contact carrier.

7. The method according to claim 6, wherein rearranging the contact carrier in step f) comprises rotating the contact carrier at a predetermined angle around the longitudinal axis of the contact carrier.

8. A fusing device for joining a plurality electrical conductors and a set of electrical terminals pre-populated in a contact carrier, the fusing device comprising:
a support unit configured to receive the contact carrier so as to allow positioning a connection portion of each of at least a first and a second electrical conductor of the plurality of electrical conductors aligned with at least a first and a second receiving section of the set of electrical terminals, respectively;
at least two electrodes configured to engage with one or more sides of the first receiving section of the set of electrical receiving the connection portion of the first electrical conductor for fusing the connection portion of the first electrical conductor and the first receiving section of the set of electrical terminals to join the electrical conductor and least one of the electrical terminals of the set of electrical terminals;
wherein the support unit is configured to position the contact carrier so as to allow the electrodes engagement to the second receiving section of the set of electrical terminals to allow the electrodes being engaged on one or more sides of the second receiving section of the set of electrical terminals receiving the connection portion of the second electrical conductor for fusing the connection portion of the second electrical conductor and the second receiving section of the set of electrical terminals pre-populated in the contact carrier by using the electrodes to join the second electrical conductor and at least one electrical terminal of the set of electrical terminals.

9. The fusing device according to claim 8, further comprising a cable fixturing unit configured to automatically arrange the connection portion of the first and/or the second electrical conductor of the plurality of electrical conductors at the first or the second receiving section of the set of electrical terminals pre-populated in the contact carrier.

10. The fusing device according to claim 8, wherein the support unit is configured to manually or automatically rotate the contact carrier along a longitudinal axis of the contact carrier and/or to translate the contact carrier at least in a plane perpendicular to the longitudinal axis of the contact carrier.
